(19) United States
(12) Patent Application Publication
(10) Pub. No.: US 2017/0168613 A1
(43) Pub. Date: Jun. 15, 2017

(54) TOUCH STRUCTURE AND METHOD FOR MANUFACTURING THE SAME

(71) Applicant: Innolux Corporation, Chu-Nan (TW)

(72) Inventors: Pei-Ying HSIEH, Chu-Nan (TW); Sheng-Shiou YEH, Chu-Nan (TW); Hung-Sheng CHO, Chu-Nan (TW); Jui-Jen YUEH, Chu-Nan (TW)

(73) Assignee: Innolux Corporation, Chu-Nan (TW)

(21) Appl. No.: 15/376,728

(22) Filed: Dec. 13, 2016

(30) Foreign Application Priority Data
Dec. 15, 2015 (CN) 201510936698.2

(51) Int. Cl. G06F 3/044

(52) U.S. Cl. CPC G06F 3/044

(57) ABSTRACT

A touch structure includes a conductive glass unit and a conductive film unit disposed on one side of the conductive glass unit. The conductive glass unit includes a glass substrate and a first patterned electrode layer. The glass substrate has a first surface and a second surface opposite to the first surface. The first surface has a first roughness, the second surface has a second roughness, and the first roughness is larger than the second roughness. The first patterned electrode layer is disposed on the second surface. The conductive film unit includes a transparent film and a second patterned electrode layer disposed on the transparent film.

This application claims the benefit of People's Republic of China application Serial No. 201510936698.2, filed on Dec. 15, 2015, the subject matter of which is incorporated herein by reference.

### BACKGROUND OF THE INVENTION

Field of the Invention

The present disclosure relates in general to a touch structure, a method for manufacturing the same and applications thereof, and more particularly to a thinned touch structure, a method for manufacturing the same and applications thereof.

Description of the Related Art

Along with the advance in the display technology, various display devices are provided one after another. Of the many display devices, the display device with touch panel has been widely used in various consumer electronic products.

Conventionally, the add-on type (out-cell type) touch sensor has three main types: the one glass solution (OGS) touch panel, the cover glass/sensor glass (GG) touch panel and the cover glass/sensor film X/sensor film Y (GFF) touch panel. The add-on type touch panel advantageously provides a diversity of flexible combinations of the touch panel and the display module. However, since the add-on type touch panel requires more materials and contains complicated stacking layers, the overall structure is thick and heavy and is not easy to be thinned.

Let the cover glass/sensor glass (GG) display panel be taken for example. One glass is used as a cover glass, and another glass is used as a sensor glass for allowing the sensor electrode formed thereon. Because the cover glass requires higher hardness, and therefore it cannot be thinned. A thinned sensor glass may have a lower mechanical strength and may be broken easily during the manufacturing process. It can be predicted that, thinning the sensor glass not only increase its processing difficulty but also decrease its yield, thereby the manufacturing cost can be increased significantly.

Therefore, it has become a prominent task for the industries to provide an advanced touch structure, a method for manufacturing the same and applications thereof.

### SUMMARY OF THE INVENTION

According to one embodiment of the present disclosure, a touch structure is provided. The touch structure includes a conductive glass unit and a conductive film unit disposed on one side of the conductive glass unit. The conductive glass unit includes a glass substrate and a first patterned electrode layer. The glass substrate has a first surface and a second surface opposite to the first surface, the first surface has a first roughness, the second surface has a second roughness, and the first roughness is larger than the second roughness. The first patterned electrode layer is disposed on the second surface. The conductive film unit includes a transparent film and a second patterned electrode layer disposed on the transparent film.

According to another embodiment of the present disclosure, a touch display device is provided. The display device includes a display panel and the aforementioned touch structure. The display panel has a light emission surface and the touch structure is disposed on the light emission surface.

According to an alternative embodiment of the present disclosure, a method for manufacturing a touch structure is provided. The manufacturing method includes following steps. A first glass substrate is provided, wherein the first glass substrate has a first surface and a second surface opposite to the first surface. A first patterned electrode layer is formed on the second surface. A first transparent film is provided; a second patterned electrode layer is then formed on the transparent film. A thinning process is performed on the first glass substrate, wherein the first surface of the first glass substrate on which the thinning process is performed has a roughness larger than that of the second surface. A lamination process is performed to laminate the first transparent film onto the first or the second surface. The sequence of the lamination process and that of the thinning process can be interchangeable.

In some embodiments, since the first patterned electrode layer and the second patterned electrode layer respectively disposed on the glass substrate and the transparent film are separately manufactured, the process for forming the first patterned electrode layer and the second patterned electrode layer does not affect the mechanical strength of the thinned glass substrate. In some embodiments, the glass substrate is thinned after two glass substrates are laminated together. Thus, during the manufacturing process, the glass substrate can be less likely to get broken and the yield of the touch structure can be increased. In some embodiments, the thinned glass substrate can serve as a cover glass of the touch structure and it does not necessitate an extra glass layer, so that the manufacturing cost of the touch structure can be reduced.

The above and other aspects of the present disclosure will become better understood with regard to the following detailed description of the non-limiting embodiment(s). The following description is made with reference to the accompanying drawings.

### BRIEF DESCRIPTION OF THE DRAWINGS

FIGS. 1A to 1H are a series of structural cross-sectional views illustrating the processing steps for forming a touch structure according to a first embodiment of the present disclosure;

FIGS. 2A to 2H are series of structural cross-sectional views illustrating the processing steps for forming a touch structure according to a second embodiment of the present disclosure; and

FIG. 3 is a structural cross-sectional view illustrating a touch display device using the touch structure of FIG. 1H according to one embodiment of the present disclosure.

### DETAILED DESCRIPTION OF THE INVENTION

In some embodiments, the present disclosure provides a thinned touch structure, method for manufacturing the same and applications thereof, not only simplifying the manufacturing process but also increasing the process yield and reducing the manufacturing cost. The objects, technical features and advantages of the present disclosure to be more easily understood by anyone ordinary skilled in the technology field, a number of exemplary embodiments are disclosed below with detailed descriptions and accompanying drawings.

It should be noted that these embodiments are for exemplification purpose only, not for limiting the scope of protection of the invention. The invention can be implemented by using other features, elements, methods and parameters. The embodiments are merely for illustrating the technical features of the invention, not for limiting the scope of protection of. Anyone skilled in the technology field of the invention will be able to make suitable modifications or changes based on the specification disclosed below without breaching the spirit of the invention. Common reference numbers designated in the accompanying drawings are used to indicate identical or similar elements.

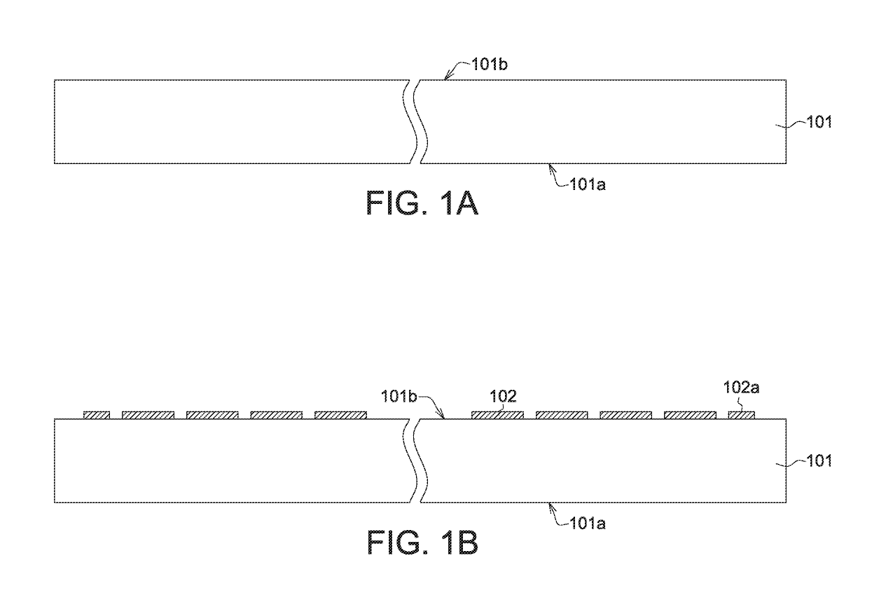

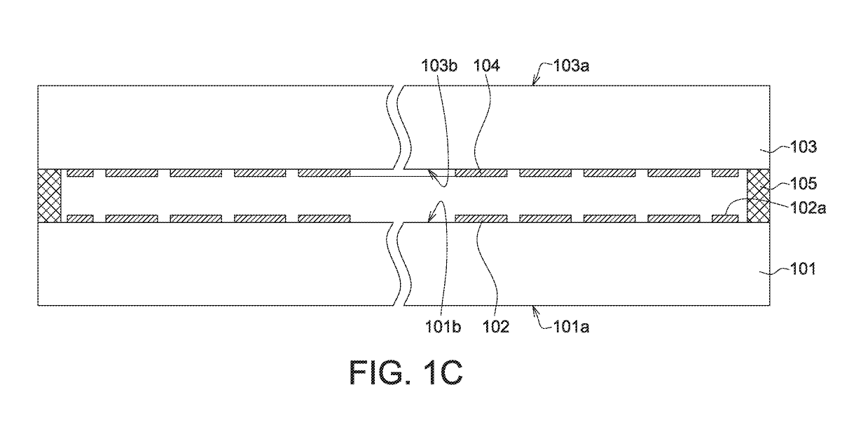

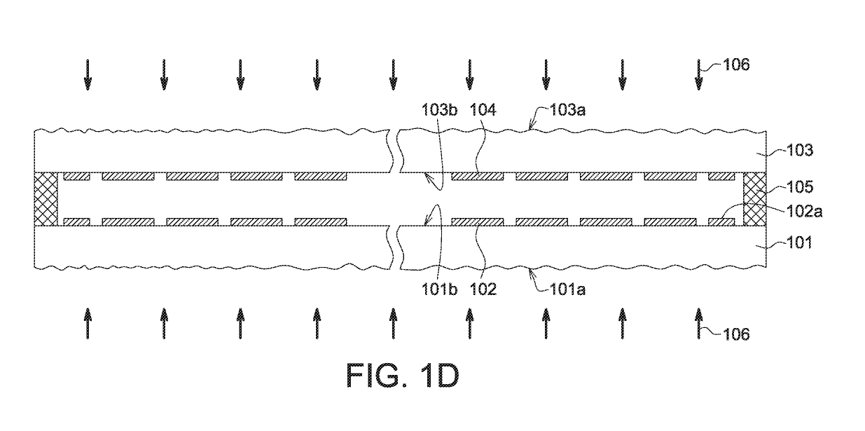

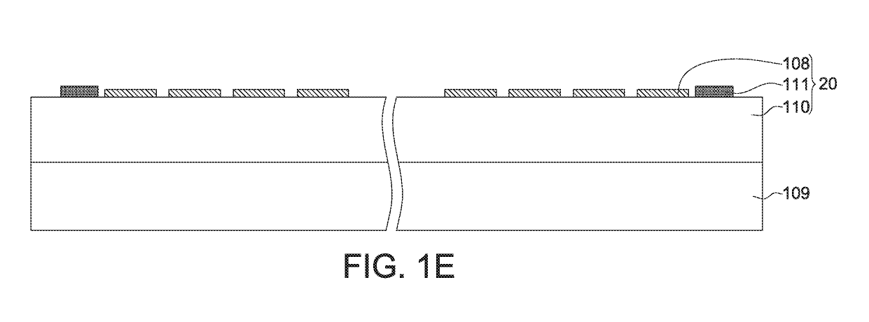

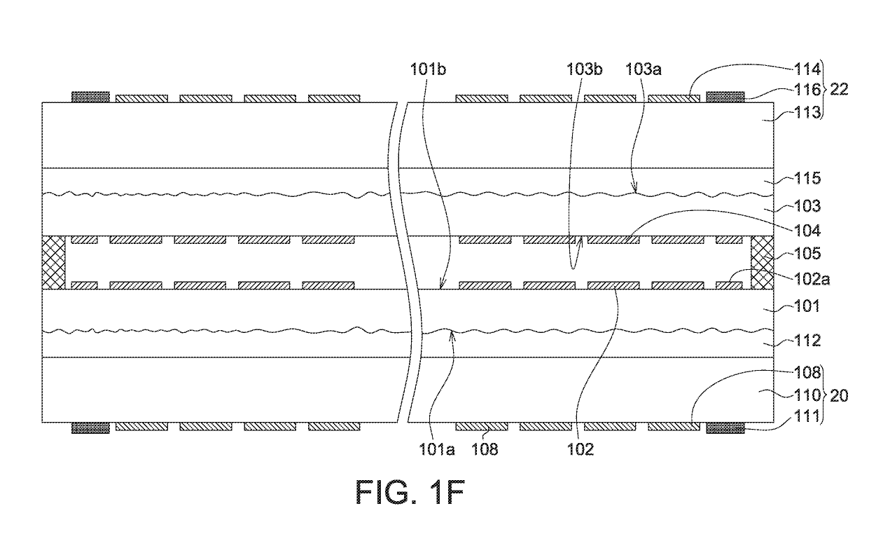

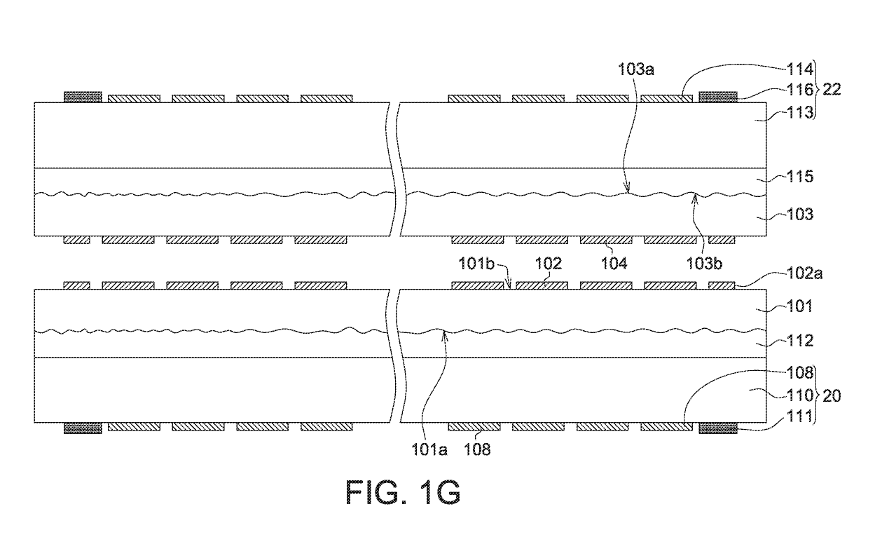

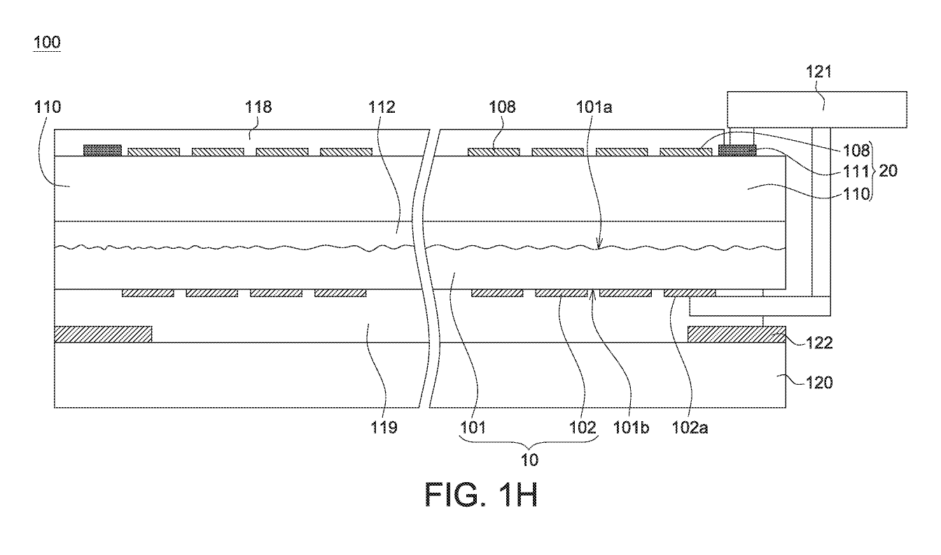

Referring to FIGS. 1A to 1H, FIGS. 1A to 1H are a series of structural cross-sectional views illustrating the processing steps for forming a touch structure 100 according to a first embodiment of the present disclosure. The method for forming the touch structure 100 includes following steps.

Firstly, a first glass substrate 101 is provided, wherein the first glass substrate 101 has a first surface 101a and a second surface 101b opposite to the first surface 101 (FIG. 1A). In some embodiments of the present disclosure, the first surface 101a and the second surface 101b can have the same roughness, and the roughness of the two surfaces may substantially range from 1 nm to 5 nm. The first glass substrate 101 has a thickness substantially ranging from 300 micrometers (μm) to 600 μm.

Then, a first patterned electrode layer 102 is formed on the second surface 101b of the first glass substrate 101. In one embodiment of the present disclosure, the first patterned electrode layer 102 can be directly in contact with the second surface 101b (see FIG. 1B). Or, a single or multiple optical compensation layers can be disposed between the first glass substrate 101 and the first patterned electrode layer 102. In some embodiments of the present disclosure, the first patterned electrode layer 102 can be formed using a deposition technology. For example, a conductive material layer is formed on the second surface 101b of the first glass substrate 101 using a sputtering process or a low-pressure chemical vapor deposition (LPCVD) process. Then, a portion of the conductive material layer is removed using a photo etching process to form the first patterned electrode layer 102 on the second surface 101b of the first glass substrate 101.

In the present embodiment, the touch structure 100 can be realized by a capacitive touch structure. For example, the first patterned electrode layer 102 can be a touch electrode, such as a sensor electrode (Rx) or a driving electrode (Tx) of the capacitive touch structure. For example, the first patterned electrode can be a sensor electrode (Rx). In some other embodiments, the first patterned electrode layer 102 further includes a trace layer 102a disposed on a peripheral region. The trace layer 102a can be electrically connected to the first patterned electrode layer 102. The trace layer 102a and the first patterned electrode layer 102 can be made of the same material using the same manufacturing process. However, the material and the method for forming the trace layer 102a are not limited to this regards, and can also be made of other conductive material such as metal, forming a metal trace layer 102a.

In some embodiments of the present disclosure, the first patterned electrode layer 102 can be an electrode layer made of a metal, a metal nitride (such as aluminum nitride (AkN)), a metal oxide, or one of the arbitrary combinations thereof. The metal oxide can be, for example, indium tin oxide (ITO), antimony tin oxide (ATO), tin oxide (SnO₂), zinc oxide (ZnO), indium oxide (InO), zinc antimonate (Zn(SbO₃)₂), antimony pentoxide (Sb2O₅), aluminum-doped zinc oxide (AZO), or indium gallium zinc oxide (IGZO). In some other embodiments of the present disclosure, the first patterned electrode layer 102 can be realized by a metal mesh structure made of a metal material selected from the group composed of copper (Cu), silver (Ag), aluminum (Al) and a combination thereof.

Refer to FIG. 1C. A second glass substrate 103 is provided. The second glass substrate 103 has a third surface 103a and a fourth surface 103b opposite to the third surface 103a, and a third patterned electrode layer 104 is formed on the fourth surface 103b. In one embodiment of the present disclosure, the third patterned electrode layer 104 may be directly in contact with the fourth surface 103b. The third patterned electrode layer 104 can be a touch electrode, such as sensor electrode or a driving electrode. For example, the third patterned electrode layer 104 can serve as a sensor electrode (Rx), of the touch structure. In the present embodiment, since the structure and material of the second glass substrate 103 and the third patterned electrode layer 104 are identical to that of the first glass substrate 101 and the first patterned electrode layer 102, the detailed structure and process for manufacturing the second glass substrate 103 and the third patterned electrode layer 104 are not redundantly repeated here. In other embodiments, the structure and material of the second glass substrate 103 and the third patterned electrode layer 104 can be different from that of the first glass substrate 101 and the first patterned electrode layer 102.

Then, the first glass substrate 101 and the second glass substrate 103 are aligned and laminated (assembled) together using a sealant 105, such that the first patterned electrode layer 102 disposed on the second surface 101b of the first glass substrate 101 can face to the third patterned electrode layer 104 disposed on the fourth surface 103b of the second glass substrate 103 (see FIG. 10).

Referring to FIG. 1D. A thinning process 106 is performed on the first surface 101a of the first glass substrate 101 and the third surface 103a of the second glass substrate 103. In one embodiment of the present disclosure, the thinning process 106 is a wet etching process using an etchant containing hydrofluoric acid (HF) solution to remove portions of the first glass substrate 101 and the second glass substrate 103. Thus, after the first surface 101a of the first glass substrate 101 is subjected to the thinning process, the first surface 101a has a roughness substantially larger than that of the second surface 101b. Meanwhile, after the third surface 103a is subjected to the thinning process, the third surface 103a will have a roughness substantially larger than that of the fourth surface 103b.

In the present embodiment, after the thinning process, the thinned first surface 101a and the thinned third surface 103a may have the same roughness, and the roughness of the two surfaces may substantially range from 1.5 to 300 nm, for example, 100 nm to 300 nm. The thinned first glass substrate 101 and the thinned second glass substrate 103 have a thickness substantially ranging from 50 μm to 300 μm (see FIG. 1D). In some other embodiments, a grinding process (not illustrated) can be performed on the thinned first surface 101a and the third surface 103a, such that the first surface 101a and the third surface 103a both have a roughness substantially ranging from 1.5 nm to 5 nm. According to one embodiment of the present disclosure, the final roughness of the first surface 101a and the third surface 103a that are subjected to the thinning process may range from 1.5 nm to 300 nm.

Referring to FIG. 1E, a first conductive film unit 20 is provided. In some embodiments of the present disclosure, the formation of the first conductive film unit 20 includes following steps. Firstly, a plasticizing material is coated on a carrying substrate 109 using a spin coating process or other method to form a first transparent film 110, such as an isotropic film, having a thickness substantially ranging from 5 μm to 50 μm.

In some embodiments of the present disclosure, the plasticizing material coated on the carrying substrate 109 can be selected from the group consisting of polyimide (PI), polyethylene terephthalate (PET) and the arbitrary combinations thereof. In the present embodiment, the first transparent film 110 can be realized by a PI film having a thickness substantially ranging from 5 μm to 10 μm. Or, in some other embodiments, the first transparent film 110 can be alternatively realized by a PET film having a thickness substantially ranging from 20 μm to 50 μm.

Then, a conductive material layer can be formed on the first transparent film 110 using a deposition technology such as a sputtering process or a low-pressure chemical vapor deposition (LPCVD) process. Then, a portion of the conductive material layer is removed using a photo etching process to form a second patterned electrode layer 108 on the first transparent film 110. In one embodiment of the present disclosure, the second patterned electrode layer 108 may be directly in contact with the first transparent film 110. Or, single or multiple optical compensation layers can be disposed between the first transparent film 110 and the second patterned electrode layer 108. In the present embodiment, the second patterned electrode layer 108 can serve as a touch electrode, such as a sensor electrode (Rx) or a driving electrode (Tx), of the capacitive touch structure.

In some embodiments of the present disclosure, the material applicable to the second patterned electrode layer 108 can be the same or similar to the material applicable to the first patterned electrode layer 102, and the similarities will not redundantly repeated here. The second patterned electrode layer 108 and the first patterned electrode layer 102 can be made of the same or different materials.

In the present embodiment, the second patterned electrode layer 108 can be realized by a transparent electrode made of ITO. Besides, the first conductive film unit 20 further includes a trace layer 111 disposed on the peripheral region. The trace layer 111 can be electrically connected to the second patterned electrode layer 108. The trace layer 111 and the second patterned electrode layer 108 can be made of the same material using the same manufacturing process. Alternatively, the trace layer 111 can be realized by other conductive material. For example, a trace layer 111 can be formed on the peripheral region of the first transparent film 110 by a metal deposition process, forming a metal trace layer 111.

Then, the first transparent film 110 and the carrying substrate 109 are separated to obtain the first conductive film unit 20 including the first transparent film 110, the second patterned electrode layer 108 and the trace layer 111, wherein both the second patterned electrode layer 108 and the trace layer 111 are disposed on the first transparent film 100. Then, refer to FIG. 1F. The first transparent film 110 is laminated onto the first surface 101a of the thinned first glass substrate 101 using an optical clear adhesive (OCA) 112, such that the second patterned electrode layer 108 is disposed on one side of the first transparent film 110 farther away from the first surface 101a of the first glass substrate 101. Therefore, through the optical clear adhesive 112, the first patterned electrode layer 102 disposed on the second surface 101b of the first glass substrate 101 can be separated from the first transparent film 110, and the second patterned electrode layer 108 disposed on the first transparent film 110 can be separated from the first glass substrate 101. In some embodiments of the present disclosure, the optical clear adhesive 112 has a thickness substantially ranging from 50 μm to 200 μm.

Meanwhile, a second conductive film unit 22 including a fourth patterned electrode layer 114, a second transparent film 113 and a trace layer 116 is provided by a process similar to that for forming the first conductive film unit 20. Similarly, the second transparent film 113 is then laminated onto the third surface 103a of the thinned second glass substrate 103 using the optical clear adhesive 115, such that the fourth patterned electrode layer 114 is disposed on one side of the second transparent film 113 farther away from the third surface 103a of the second glass substrate 103. Through the optical clear adhesive 115, the third patterned electrode layer 104 disposed on the fourth surface 103b of the second glass substrate 103 can be separated from the second transparent film 113, and the fourth patterned electrode layer 114 disposed on the second transparent film 113 can be separated from the second glass substrate 103 (see FIG. 1F).

Then, the sealant 105 is removed using a wheel cutter, such that the first glass substrate 101 having the first conductive film unit 20 laminated thereon and the second glass substrate 103 having the second conductive film unit 22 laminated thereon are separated from each other to form two independent manufacturing units (see FIG. 1G). The two independent manufacturing units are then subjected to a series of subsequent manufacturing processes individually. For the convenience of description, only the manufacturing processes subsequently performed on the first glass substrate 101 having a first conductive film unit 20 laminated thereon are described below, since the subsequent manufacturing processes performed on the two independent manufacturing units are the same.

Refer to FIG. 1H. The touch structure 100 includes a conductive glass unit 10 and a conductive film unit 20. The conductive glass unit 10 includes a glass substrate 101, and a first patterned electrode layer 102 disposed on the second surface 101b of the glass substrate 101. The conductive film unit 20 includes a first transparent film 110 and a second patterned electrode layer 108 disposed on the first transparent film 110. The conductive glass unit 10 and the conductive film unit 20 can be laminated together using the optical clear adhesive 112. The glass substrate 101 has a first surface 101a and a second surface 101b opposite to the first surface. The first surface 101a has a first roughness, the second surface 101b has a second roughness, and the first roughness is larger than the second roughness. According to one embodiment of the present disclosure, the first roughness may range from 1.5 nm to 300 nm, and the second roughness may range from 1 nm to 5 nm.

Then, an external element, such as a flexible printed circuit (FPC) 121, is provided. The external element 121 is electrically connected to the trace layer 111 disposed on the first transparent film 110 and the trace layer 102a disposed on glass substrate 101. The trace layer 111 and the trace layer 102a respectively have a conductive connection region (bonding region) for electrically contacting the external element 121. The trace layer and the external element can be electrically connected with each other by a thermo-compression bonding, an anisotropic conductive adhesive, or a solder wire.

A transparent passivation layer 118 is then formed to cover the first transparent film 110 and the second patterned electrode layer 108. An optical clear adhesive 119 is subsequently coated on the second surface 101b of the first glass substrate 101 and the first patterned electrode layer 102. A frame 122 is formed on the cover glass 120 and the cover glass 120 is placed to cover the optical clear adhesive 119. Thus, the process for forming the touch control structure 100 as shown in FIG. 1H is completed.

According to the manufacturing process disclosed above, the first glass substrate 101 and the second glass substrate 103 having the same structure can be laminated together using the sealant 105, and the first glass substrate 101 and the second glass substrate 103 can be thinned at the same time. According to some embodiments, not only the mechanical strength of the first glass substrate 101 and the second glass substrate 103 during the thinning process can be increased, the production efficiency thereof can be also improved. According to some embodiments, since the manufacturing processes for forming the first patterned electrode layer 102 and the third patterned electrode layer 104 are performed on the non-thinned first glass substrate 101 and the non-thinned second glass substrate 103, and the manufacturing processes for forming the second patterned electrode layer 108 and the fourth patterned electrode layer 114 are performed on the carrying substrate 109, thus no or less mechanical impact may occur on the thinned first glass substrate 101 and the second glass substrate 103. As a result, during the manufacturing process, the likelihood of a fracture occurring on the first glass substrate 101 and the second glass substrate 103 can be largely reduced, and the process yield can be increased.

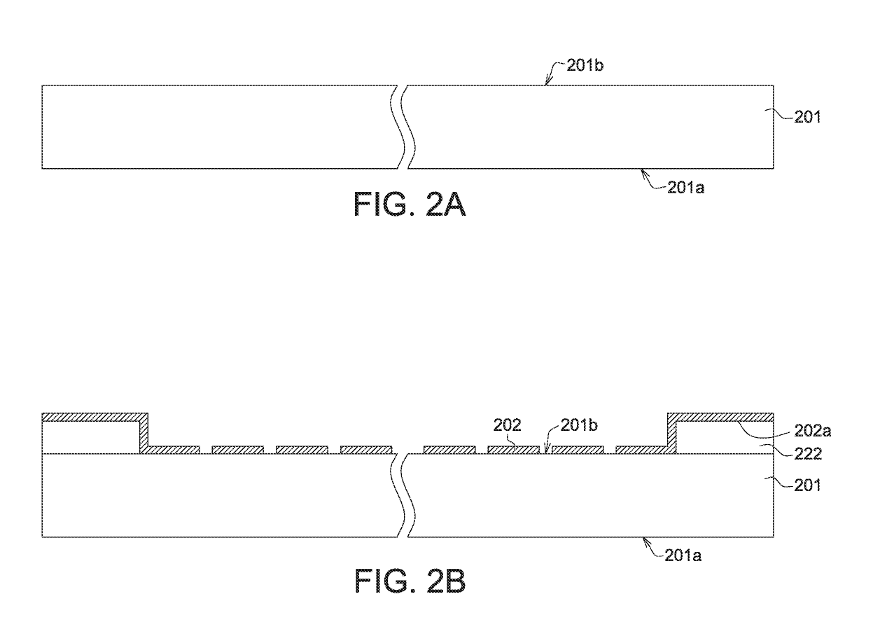

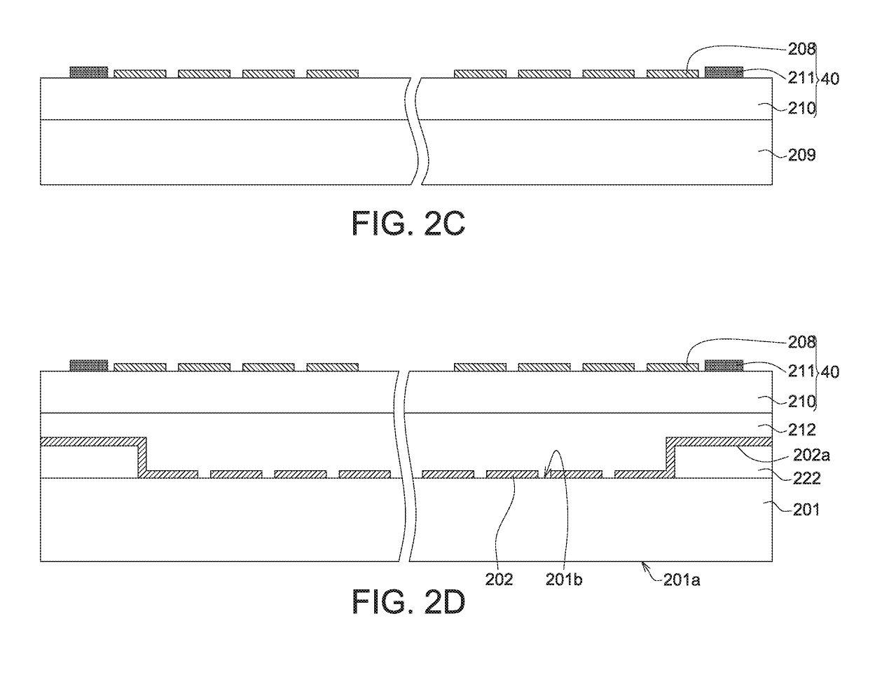

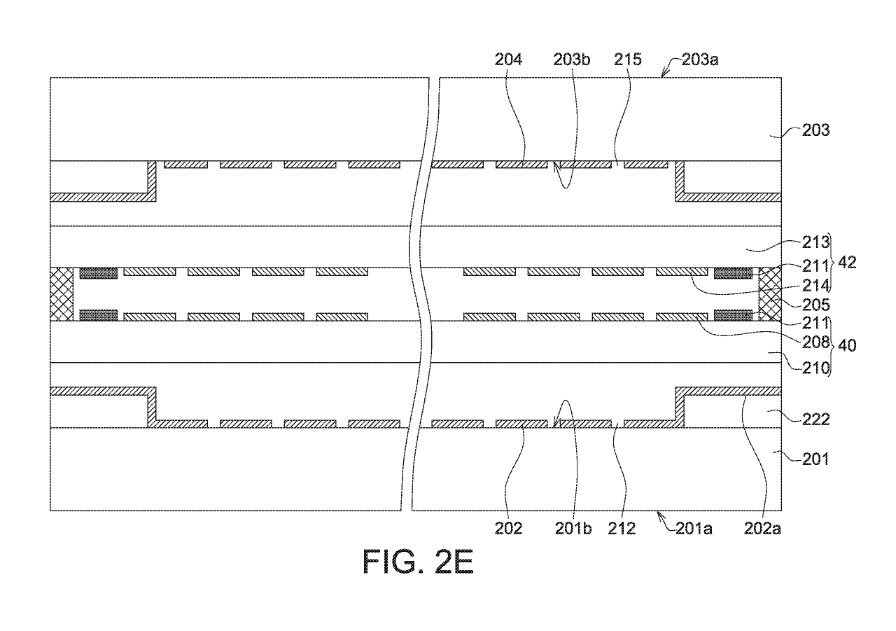

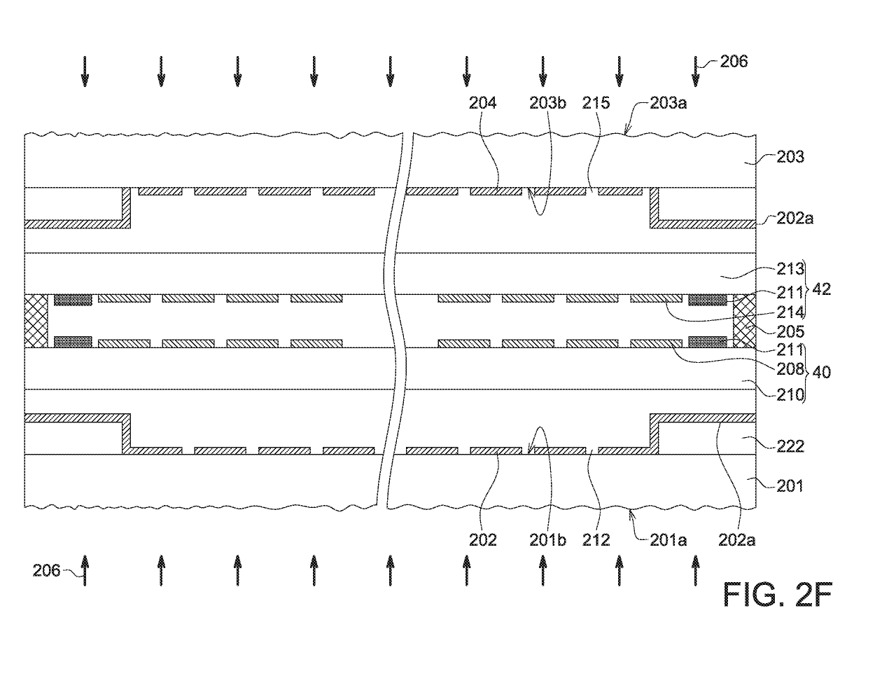

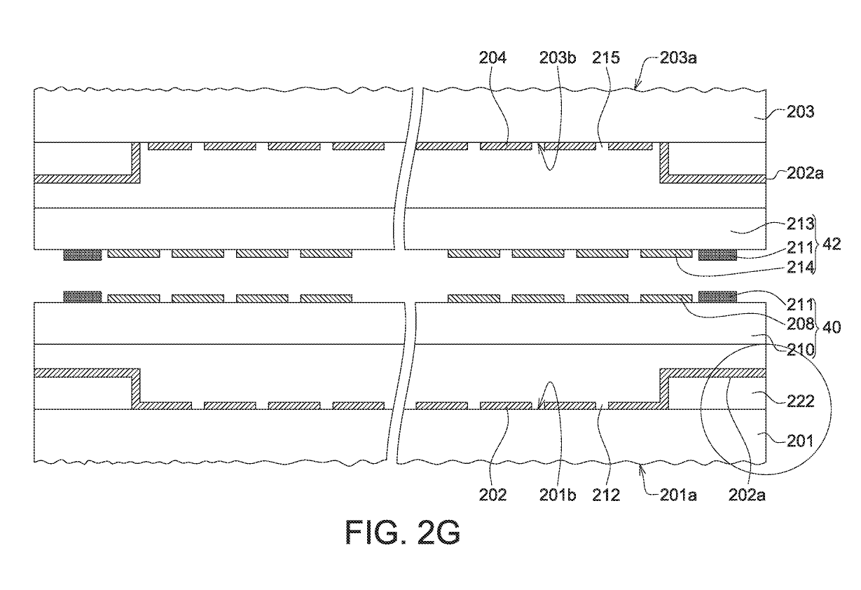

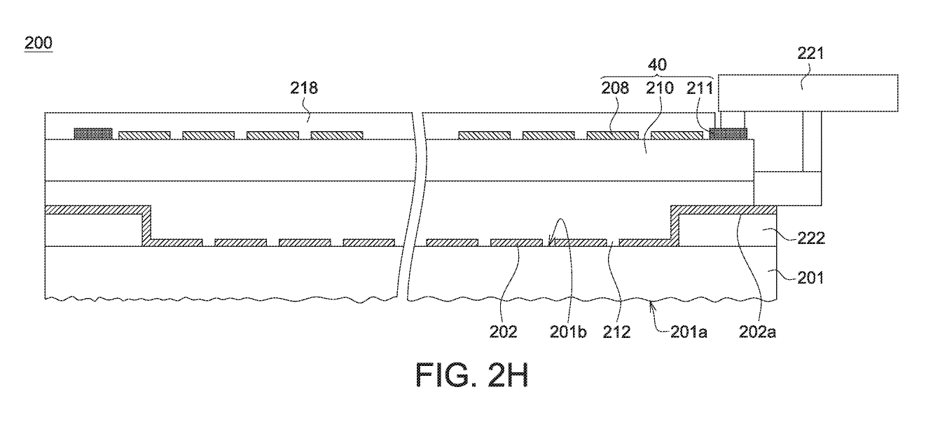

Referring to FIGS. 2A to 2G, FIGS. 2A to 2G are a series of structural cross-sectional views illustrating the processing steps for forming a touch structure 200 according to a second embodiment of the present disclosure. The method for forming the touch structure 200 includes following steps.

Firstly, a first glass substrate 201 is provided. The first glass substrate 201 has a first surface 201a and a second surface 201b opposite to the first surface 201a (FIG. 2A). In some embodiments of the present disclosure, the first surface 201a and the second surface 201b can have the same roughness, and the roughness of the two surfaces may substantially range from 1 nm to 5 nm. The first glass substrate 201 has a thickness substantially ranging from 300 μm to 600 μm.

Then, a first patterned electrode layer 202 is formed on the second surface 201b of the first glass substrate 201. In one embodiment of the present disclosure, the first patterned electrode layer 202 can be directly in contact with the second surface 201b and cover on the frame 222 that is disposed on the peripheral region of the second surface 201b (see FIG. 2B). In some embodiments of the present disclosure, the method and applicable material for forming the first patterned electrode layer 202 are similar to that of the first patterned electrode layer 102, and the similarities are not redundantly repeated here. In the present embodiment, the touch structure 200 is realized by a capacitive touch structure; the first patterned electrode layer 202 can serve as a touch electrode, such as a sensor electrode (Rx) or a driving electrode (Tx), of the capacitive touch structure. In another embodiment, the first patterned electrode layer 202 further includes a trace layer 202a disposed on the peripheral region and covering the frame 222. The trace layer 202a can be electrically connected to the first patterned electrode layer 202. The trace layer 202a can be a metal trace layer.

Refer to FIG. 2C. A first conductive film unit 40 is provided. In some embodiments of the present disclosure, the formation of the first conductive film unit 40 includes following steps. Firstly, a plasticizing material is coated on a carrying substrate 209 using a spin coating process or other method to form a first transparent film 210, such as an isotropic film. Then, a second patterned electrode layer 208 is formed. In the present embodiment, the second patterned electrode layer 208 can serve as a touch electrode, such as a sensor electrode (Rx) or a driving electrode (Tx), of the capacitive touch structure.

In some embodiments of the present disclosure, the method and applicable material for forming the first transparent film 210 are similar to that for forming the first transparent film 110 of the first embodiment, and the similarities are not redundantly repeated here. The method and applicable material for forming the second patterned electrode layer 208 are similar to that for forming the second patterned electrode layer 108 of the first embodiment, and the similarities are not redundantly repeated here.

In the present embodiment, the second patterned electrode layer 208 can be a transparent electrode made of ITO. Besides, the first conductive film unit 40 further includes a trace layer 211 disposed on the peripheral region. The process and material for forming the trace layer 211 can be the same to that for forming the second patterned electrode layer 208. However, the process and material for forming the trace layer 211 are not limited to this regards, and the trace layer 211 can be made of other conductive material. For example, the trace layer 211 can be formed on the peripheral region of the first transparent film 210 by a metal deposition process, forming a metal trace layer 211. The trace layer 211 can be electrically connected to the second patterned electrode layer 208.

Then, the first transparent film 210 and the carrying substrate 209 are separated to obtain the first conductive film unit 40 including a first transparent film 210, and a second patterned electrode layer 208 and a trace layer 211 both disposed on the first transparent film 210. Then, referring to FIG. 2D, the first transparent film 210 is laminated onto the second surface 201b of the first glass substrate 201 using an optical clear adhesive 212, such that the second patterned electrode layer 208 is disposed on one side of the first transparent film 210 farther away from the second surface 201b of the first glass substrate 201, and the first transparent film 210 can be separated from the first glass substrate 201 through the optical clear adhesive 212. The optical clear adhesive 212 can have a thickness substantially ranging from 50 μm to 200 μm. Therefore, through the optical clear adhesive 212, the first patterned electrode layer 202 disposed on the second surface 201b of the first glass substrate 201 can be separated from the first transparent film 210; and the second patterned electrode layer 208 disposed on the first transparent film 210 can be separated from the first glass substrate 201 (see FIG. 2D).

Referring to FIG. 2E, a second glass substrate 203 is provided,. The second glass substrate 203 has a third surface 203a and a fourth surface 203b opposite to the third surface 203a. A third patterned electrode layer 204 is formed on the fourth surface 203b and directly in contact with the fourth surface 203b. A second conductive film unit 42 including a fourth patterned electrode layer 214, a second transparent film 213 and a trace layer 211 is provided by a process similar to that for forming the first conductive film unit 40. The second transparent film 213 is then laminated onto the fourth surface 203b of the second glass substrate 203 using an optical clear adhesive 215, such that the fourth patterned electrode layer 214 is disposed on one side of the second transparent film 213 farther away from the fourth surface 203b of the second glass substrate 203.

Similarly, through the optical clear adhesive 215, the fourth patterned electrode layer 214 can be separated from the second glass substrate 203, and the third patterned electrode layer 204 can be separated from the second transparent film 213. In the present embodiment, the method and material for forming the glass substrate, the patterned electrode layer and the transparent film can be obtained with reference to above disclosure, and are not redundantly repeated here.

Then, the first glass substrate 201 having a first conductive film unit 40 laminated thereon and the second glass substrate 203 having a second conductive film unit 42 laminated thereon are aligned and laminated together (assembled) using a sealant 205, such that the first transparent film 210 disposed on the second surface 201b of the first glass substrate 201 faces the second transparent film 213 disposed on the fourth surface 203b of the second glass substrate 203 (see FIG. 2E).

Refer to FIG. 2F. A thinning process 206 is performed on the first surface 201a of the first glass substrate 201 and the third surface 203a of the second glass substrate 203. The thinning process 206 can be a wet etching process using an etchant containing hydrofluoric acid (HF) solution to remove portions of the first glass substrate 201 and the second glass substrate 203. Thus, the first surface 201a of the first glass substrate 201 has a roughness substantially larger than that of the second surface 201b. Meanwhile, after the third surface 203a is subjected to the thinning process, the third surface 203a may have a roughness substantially larger than that of the fourth surface 203b.

In the present embodiment, the thinned first surface 201a and the thinned third surface 203a can have the same roughness; the roughness of the two surfaces may substantially range from 100 nm to 300 nm. The thinned first glass substrate 201 and the thinned second glass substrate 203 both have a thickness substantially ranging from 50 μm to 300 μm. In some other embodiments, a grinding process (not illustrated) can be performed on the thinned first surface 201a and thinned the third surface 203a, such that the first surface 201a and the third surface 203a both have a roughness substantially ranging from 1.5 nm to 5 nm. According to one embodiment of the present disclosure, the final roughness of the first surface 201a and the third surface 203a that are subjected to the thinning process may range from 1.5 nm to 300 nm.

Then, the sealant 205 is removed using a wheel cutter, such that the first glass substrate 201 having a first conductive film unit 40 laminated thereon and the second glass substrate 203 having a second conductive film unit 42 laminated thereon are separated from each other to form two independent manufacturing units (see FIG. 2G). These two independent manufacturing units are then subjected to a series of subsequent manufacturing processes individually. Details of the subsequent manufacturing process of the first glass substrate 201 having a first conductive film unit 40 laminated thereon is disclosed below.

Referring to FIG. 2H, then, an external element, such as a flexible printed circuit (FPC) 221, is provided. The external element 221 is electrically connected to the trace layer 211 disposed on the first transparent film 210 and the trace layer 202a disposed on glass substrate 201. The trace layer 211 and the trace layer 202a respectively have a conductive connection region (bonding region) for electrically contacting the external element 221. The trace layer and the external element can be conductively connected with each other by a thermo-compression bonding, an anisotropic conductive adhesive, or a solder wire. A transparent passivation layer 218 is subsequently formed to cover the first transparent film 210 and the second patterned electrode layer 208. Thus, the touch structure 200 as shown in FIG. 2H is completed. Since the thinned first glass substrate 201 can serve as a cover glass of the touch structure 200 to protect the touch structure 200, thus no extra glass layer is required, and the manufacturing cost can be reduced.

According to the manufacturing process disclosed above, the first glass substrate 201 and the second glass substrate 203 having the same structure can be laminated together using the sealant 205, and the first glass substrate 201 and the second glass substrate 203 can be thinned at the same time. According to some embodiments, not only the mechanical strength of the first glass substrate 201 and the second glass substrate 203 during the thinning process can be increased, the production efficiency thereof can be also improved. According to some embodiments, since the processes for forming the first patterned electrode layer 202 and the third patterned electrode layer 204 are performed on the non-thinned first glass substrate 201 and the non-thinned second glass substrate 203, and the processes for forming the second patterned electrode layer 208 and the fourth patterned electrode layer 214 are performed on the carrying substrate 209, thus no or less mechanical impact may occur on the thinned first glass substrate 201 and the second glass substrate 203. As a result, during the manufacturing process, the likelihood of a fracture occurring on the first glass substrate 201 and the second glass substrate 203 can be largely reduced, and the process yield can be increased.

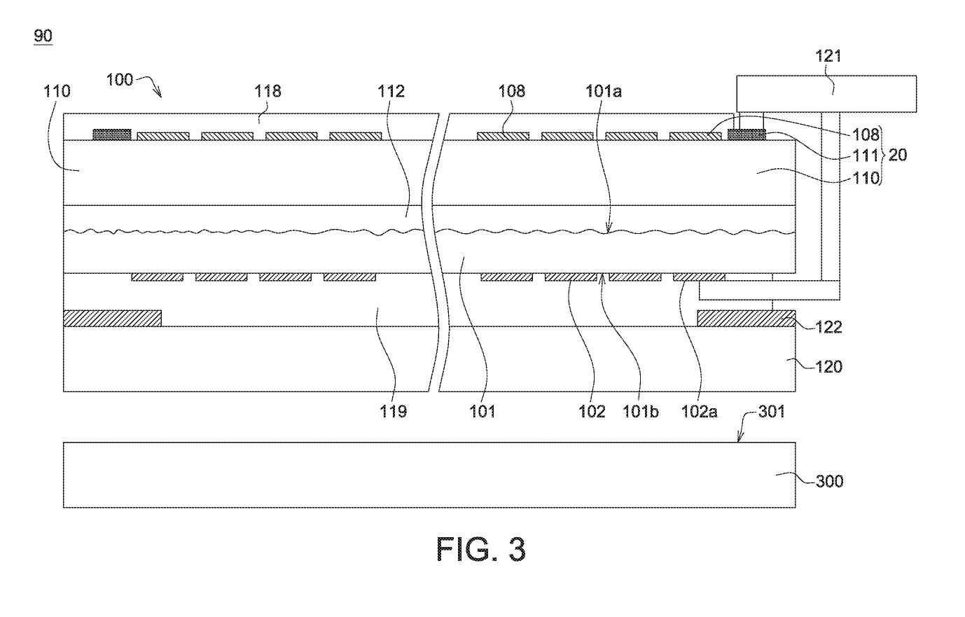

Referring to FIG. 3, FIG. 3 is a structural cross-sectional view illustrating a touch display device 90 using the touch structure 100 of FIG. 1H according to one embodiment of the present disclosure. In some embodiments of the present disclosure, the touch display device 90 is an add-on type touch display panel, at least including a display panel 300 and the touch structure 100 of FIG. 1H. The display panel 300 can be realized by (for example) a liquid crystal display (LCD), a light-emitting diode (LED) display panel, an organic light-emitting diode (OLED) display panel or an electronic ink (E-Ink) display panel. The display panel 300 has a light emission surface 301, and the touch structure 100 is disposed on the light emission surface 301.

In some embodiments, a glass substrate is provided, a first patterned electrode layer is formed on one side of the glass substrate, and a thinning process is performed on the other side of the glass substrate. Then, a conductive film unit having a second patterned electrode layer is laminated onto the glass substrate. In some embodiments, firstly, a first patterned electrode layer is formed on one side of a glass substrate; then, a conductive film unit having a second patterned electrode layer is laminated onto the first patterned electrode layer; subsequently, a thinning process is performed on the other side of the glass substrate.

In some embodiments, since the first patterned electrode layer and the second patterned electrode layer respectively disposed on the glass substrate and the transparent film are separately manufactured, thus the process of forming the first patterned electrode layer and the second patterned electrode layer does not affect the mechanical strength of the thinned glass substrate. In some embodiments, the glass substrates are thinned after two glass substrates are laminated together. Thus, during the manufacturing process, the glass substrate can be less likely to get broken and the yield of the touch structure can be increased. In some embodiments, the thinned glass substrate can serve as a cover glass of the touch structure and it does not necessitate an extra glass layer, so that the manufacturing cost of the touch structure can be reduced.

While the invention has been described by way of example and in terms of the embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch structure, comprising:
a conductive glass unit, comprising:
a glass substrate having a first surface and a second surface opposite to the first surface, wherein the first surface has a first roughness, the second surface has a second roughness, and the first roughness is larger than the second roughness; and
a first patterned electrode layer disposed on the second surface; and
a conductive film unit disposed on one side of the conductive glass unit and comprising:
a transparent film; and
a second patterned electrode layer disposed on the transparent film.

2. The touch structure according to claim 1, wherein the first roughness substantially ranges from 1.5 nm to 300 nm, and the second roughness substantially ranges from 1 nm to 5 nm.

3. The touch structure according to claim 1, further comprising an optical clear adhesive disposed between the conductive glass unit and the conductive film unit,
wherein the transparent film is laminated on the first surface by the optical clear adhesive, and the second patterned electrode layer is disposed on one side of the transparent film farther away from the first surface.

4. The touch structure according to claim 1, further comprising an optical clear adhesive disposed between the conductive glass unit and the conductive film unit,
wherein the transparent film is laminated on the second surface by the optical clear adhesive, and the second patterned electrode layer is disposed on one side of the transparent film farther away from the second surface.

5. The touch structure according to claim 1, wherein the transparent film is an isotropic film.

6. The touch structure according to claim 5, wherein the isotropic film comprises a plasticizing material selected from a group consisting of polyimide (PI), polyethylene terephthalate (PET) and arbitrary combinations thereof.

7. A touch display device, comprising:
a display panel having a light emission surface; and
the touch structure according to claim 1 disposed on the light emission surface.

8. A method for manufacturing a touch structure, comprising:
providing a first glass substrate having a first surface and a second surface opposite to the first surface;
forming a first patterned electrode layer on the second surface;
providing a first transparent film;
forming a second patterned electrode layer on the first transparent film;
performing a thinning process on the first glass substrate, such that the first surface of the first glass substrate that is subjected to the thinning process has a roughness larger than that of the second surface; and
performing a lamination process to laminate the first transparent film on the first surface or the second surface.

9. The method according to claim 8, wherein the thinning process is performed after the lamination process.

10. The method according to claim 8, wherein the thinning process is performed before the lamination process.
